(19) United States
(12) Patent Application Publication
(10) Pub. No.: US 2007/0098370 A1
(43) Pub. Date: May 3, 2007

(54) Digital video recorder

(76) Inventors: Mark Wells, Alexandria, VA (US); George Kolesar, Burke, VA (US)

Correspondence Address: DICKSTEIN SHAPIRO LLP, 1825 EYE STREET NW, Washington, DC, 20006-5403, US

(21) Appl. No.: 11/260,277

(22) Filed: Oct. 28, 2005

(51) Int. Cl. H04N 7/26

(52) U.S. Cl. 386/112

(57) ABSTRACT

A digital video recording system and method for recording video data. The digital video recording system has a video recording device configured to receive video input from the video input device. The video recording device includes a server, a plurality of video encoder cards, and a storage control module. Each encoder card is configured to convert analog video data to digital Mpeg4 video at a sustained rate of at least FD1. The storage control module is configured to write user defined temporal video segments to the storage device. The system also includes a video input device, a storage device, an activation device configured to provide an activation signal to the video recording device, and an output device capable of displaying video data recorded by the video recording device. The video recording device can be in communication with a computer network.

### FIELD OF THE INVENTION

The present invention relates to video recording devices, and particularly to digital video recorders and network video recorders.

### BACKGROUND OF THE INVENTION

Video recording devices, such as digital hard disk video recorders or digital network recorders, are used in video monitoring, surveillance and security systems. Conventionally, such a device receives a video signal, continuously records the signal and outputs the recorded signal for viewing by a user.

Digital Video Recorders (DVRs) and Network Video Recorders (NVRs) are commonly used with associated video cameras and monitors. Video data is recorded in digital format on a digital medium, such as a hard disk drive. Further included within the DVR or NVR is an encoder for digitizing the received signal (in the case of an analog input signal), encoding the signal and compressing the signal for storage on the hard drive. Decoder functionality then decodes and decompresses the stored television signal and outputs a signal to a monitor for viewing by a user.

Typically, when video is written to a drive of a DVR or NVR system, it is written temporarily until the video has stopped recording. The file is then closed and the data is written to the hard drive. If the encoder malfunctions and stops at a point during the recording, the data is lost. Additionally, certain industries have specific requirements for monitoring applications. For example, interrogation video for law enforcement applications may be required to have a particular resolution, audio and a time code.

Accordingly, it is desirable to have a DVR or NVR system that is better able to maintain data in the event of a system disruption. Additionally, a video monitoring system and method with specialized features for particular industries, such as law enforcement, is needed.

### BRIEF SUMMARY OF THE INVENTION

The present invention provides a digital video recording system and method for recording video data. The digital video recording system has a video recording device configured to receive video input from the video input device. The video recording device includes a server, a plurality of video encoder cards, and a storage control module. Each encoder card is configured to convert analog video data to digital Mpeg4 video at a sustained rate of at least FD1. The storage control module is configured to write user defined video segments to the storage device. The system also includes a video input device, a storage device, an activation device configured to provide an activation signal to the video recording device, and an output device capable of displaying video data recorded by the video recording device. The video recording device can be in communication with a computer network.

Additional features of the present invention will be apparent from the following detailed description and drawings, which illustrate exemplary embodiments of the invention.

### BRIEF DESCRIPTION OF THE DRAWINGS

FIG. 1 is a block diagram representing a digital video recorder system according to an exemplary embodiment of the invention;

FIG. 2 is a diagram of a configuration for the circuitry components of a digital video recorder according to an exemplary embodiment of the invention;

FIG. 3 is a block diagram showing the signaling flow of the digital video recorder of FIG. 2 according to an exemplary embodiment of the invention;

FIG. 4 is a block diagram depicting the interface connections of the digital video recorder of FIG. 2; and

FIG. 5 is a diagram of a network video recorder system according to an exemplary embodiment of the invention.

### DETAILED DESCRIPTION OF THE INVENTION

In the following detailed description, reference is made to the accompanying drawings, which form a part hereof and show by way of illustration specific embodiments that the invention may be practiced. In the drawings, like reference numerals refer to like elements. The illustrated embodiments are described in sufficient detail to enable those skilled in the art to practice the invention, and it is to be understood that other embodiments may be utilized, and that structural and logical changes may be made without departing from the spirit and scope of the present invention. The progression of process steps described is exemplary of embodiments of the invention; however, the sequence of steps is not limited to that set forth herein and may be changed, with the exception of steps necessarily occurring in a certain order.

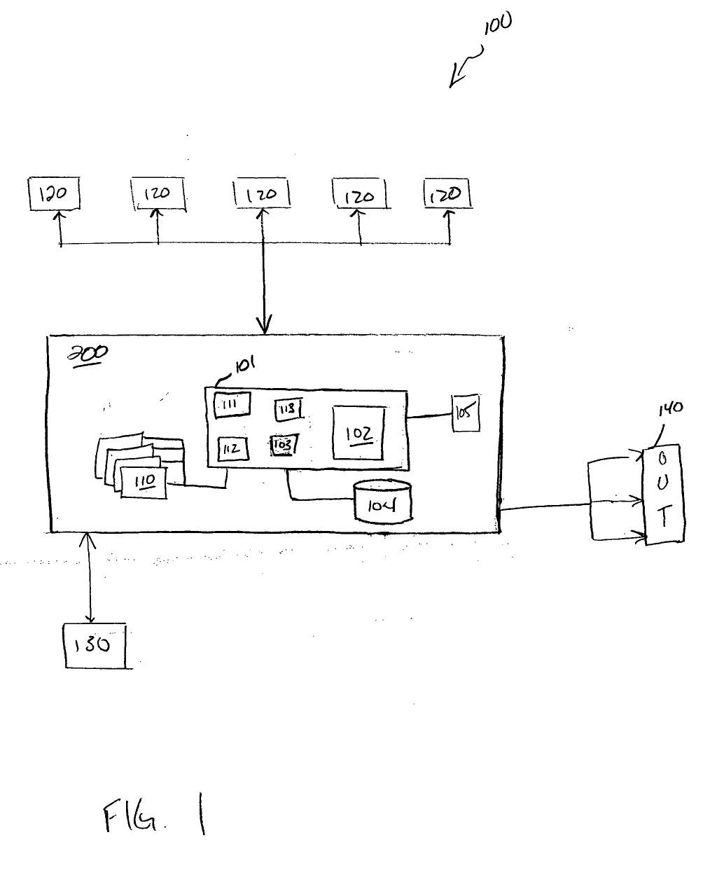

FIG. 1 is a block diagram representing a digital video recorder system according to an exemplary embodiment of the invention. The system 100 includes an integrated DVR device 200. The DVR 200 can provide reliable video and audio data storage that is compatible with law enforcement applications.

The DVR 200 includes a server 101, such as, but not limited to a standard Intel-based server. Any form of operating system 102, including Windows 2000 or 2003 operating system, and a control module 103 configured to control processes of the DVR 200 running on the server 101. The server 101 also includes a storage control module 111, an activation control module 112, and, optionally, at least one other feature module 113. Each of the modules 103, 111, 112, 113 can be computer program applications running on the server 101 or hardware/software devices or entirely hardware elements. The DVR 200 also has a user interface 105 for accepting inputs. Further, the DVR 200 also includes video/audio encoder cards 110, for example Mpeg4 cards; and a storage device 104, such as a hard drive, disk or an array of drives.

The DVR 200 is in communication with one or more video and/or audio input devices 120. The input devices 120 are, for example, video cameras having audio recording devices.

The DVR can also be in communication with an activation device 130. The activation device 130 is configured to provide an activation signal. In response to this signal, the DVR 200 begins recording video data. Examples of possible activation devices include a switch, a client computer, a voice input device, a motion detector, a timer, an alarm device, among others. Optionally, the activation device can be included in the DVR 200.

The DVR 200 is also in communication with one or more output devices 140, which are configured to display the video data and output the audio data recorded by the DVR 200. The DVR 200 can support multiple outputs from a single input.

The encoder cards 110 enable the DVR 200 to convert analog video to digital Mpeg4 video compliant with the MPEG4 (ISO 14496) standard including all levels of the SP (Simple Profile) and levels 1 thru 5 of the ASP (Advanced Simple Profile). In one embodiment the encoder cars 110 enable the DVR 200 to convert analog video to digital MPEG4 video at a sustained rate of FD1 (720×506 pixels, 30 frames per second, up to 4 Mbits per second) or better. Preferably, the cards 110 also enable audio recording that is synchronized with the video recording. The DVR 200 can process multiple simultaneous streams of video and synchronized audio. In contrast, conventional DVR devices can do one stream or less with synchronized audio, and are limited to one stream or less FD1 stream per DVR device.

Law enforcement video typically has different requirements than surveillance video. Surveillance video is generally 320×240 pixels in size, 5 to 12 frames a second and about 100 to 250 Kbs data rate. Certain law enforcement video, particularly interrogation video, must be 640×480 pixels in size (720×480 pixels is preferred), about 30 frames a second and a data rate of at least 1.5 Mbs. Interrogation video must also have audio, whereas surveillance video does not typically have audio. Therefore, the system 100 is suitable for law enforcement applications.

According to one exemplary embodiment, the DVR 200 can sustain simultaneous FD1 captures of video and audio for more than 200 hours without failure or loss of data. Conventional systems that capture video do so by writing the data to a disk drive. If the conventional system were to crash during the recording, all video and audio data would be lost. To address this problem, other systems write each frame of the video as an image. This method consumes enormous amounts of disk space and it is processor-intensive to reassemble the image back into a video. This process also does not work in real time.

To support reliable storage, the DVR 200 includes the storage control module 111. The storage control module 111 provides a more efficient method of managing disk storage than conventional DVR devices. Additionally, storage occurs during recording, rather than subsequent to recording.

The storage control module 111 writes temporal video segments to the storage device 104. The length of a video segment is set to a default length, but can be redefined as desired by the user. The segments can range in length from seconds or less to hours or more. During recording, the video data recorded during a segment is written to the storage device 104 upon the expiration of the segment. For example, where the defined segment length is one hour, every hour during recording, the video data is closed and permanently written to the storage device 104. Where recording is stopped prior to the expiration of a full segment, the final segment portion is written to the storage device 104 upon termination of recording. In this way, loss of video is limited should the system 100 fail during recording.

Optionally, the video storage control module 111 is also configured to provide a redundancy function. For this, the DVR 200 is configured such that two encoder cards 110 record the same video and audio simultaneously. If one encoder card 110 fails, the redundant secondary encoder card 110 can provide the video and audio that was lost. This function also works for video segments. If a segment recorded by the primary encoder card 110 is defective, the video storage control module 111 transfers the corresponding segment from the secondary encoder card 110 back to the primary to repair the defective file.

The activation control module 112 responds to an activation signal received from the activation device 130 and initiates recording. The DVR 200 can be activated to begin recording by one or more types of activation signals. For example, recording can be activated by an event, motion, an alarm, as scheduled by a user, or manually. Additionally, the DVR 200 can be activated for recording by voice or by a computer program application running on the activation device 130.

Optionally, the DVR 200 can support additional features. Each additional feature can be provided as a respective feature module 113 (shown as a single module in FIG. 1). For example, the DVR 200 can include a module 113 configured to translate languages, a module 113 configured to transcribe spoken words from recorded audio data, a module 113 configured for streaming of video and audio content (both live and on demand) to output device 140, and/or a module 113 configured to provide layered voice analysis and analyze audio data for deceptive or false statements.

Preferably, the DVR can also include a module 113 for image and/or audio processing. Audio processing improves the quality of the audio while recording, and compensates for poor acoustics in the recording room. Image processing improves image quality and can include color correction, gamma correction, and transitions between input device 120 (e.g., camera) angles in real time should there be more than one device 120 recording a common location. The DVR 200 can also be configured to support other features that are known in the art.

Preferably, the DVR 200 also includes a feature module 113 configured to enable customized metadata (data about data) capture along with the video and audio recording. The metadata is stored along with the video and audio data and can be retrieved through search methods. The metadata also can be integrated with data assets systems for storing and managing data and databases outside the system 100. Law enforcement video must include a time code associated with the video, which includes a display for milliseconds. Accordingly, the time code is included as metadata associated with the video data. Desirably, the time code is displayed upon playback of the video data.

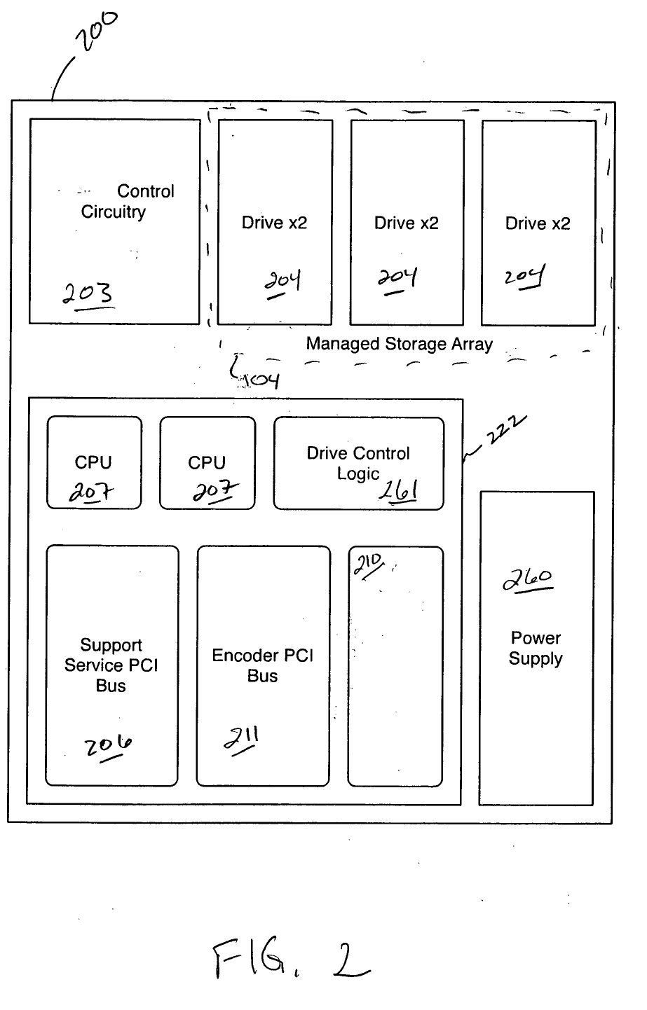

FIG. 2 is a diagram of an exemplary configuration for the circuitry components of the DVR 200. The present invention can be configured differently so long as the functionality shown in FIG. 1 can be provided. The DVR 200 includes a motherboard 222, which includes dual central processing units (CPUs) 207. In the illustrated embodiment, the CPUs are Pentium 4 class with 2 GB RAM although any other conventionally known CPU can be used. The motherboard 222 also includes a Peripheral Component Interconnect (PCI) bus 206 for digital input/output components and a PCI bus 211 for the encoder cards 110. Drive control logic circuitry 261 and memory and interface circuitry 210 are also included on the motherboard 222. The DVR 200 also includes the storage device 104. In the illustrated embodiment, the storage device 104 is a managed storage array having six Ultra320 SCSI drive bays for hard drives. Further, the DVR 200 includes a power supply 260 and control circuitry 203 for controlling the DVR 200 functions and features.

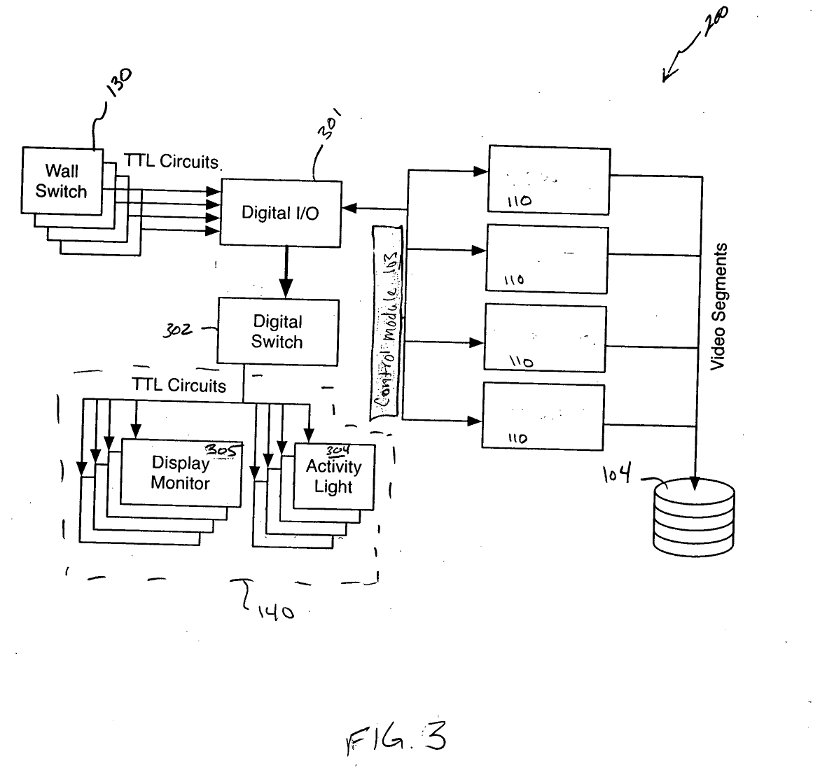

FIG. 3 is a block diagram showing the signaling flow of the DVR 200 of FIG. 2 according to an exemplary embodiment of the invention. In the embodiment illustrated in FIG. 3, the activation device 130 is a plurality of wall switches. Each of the switches 130 serves to activate a particular encoder card 110 or set of cards 110, where the redundancy function is employed.

The DVR 200 takes an analog input from the input devices 120 (FIG. 1), which triggers a digital signal from a digital input output/device 301 to the control module 103. The control module 103 activates video and audio encoding on specific cards 110 in the DVR 200. The particular cards 110 activated depend on the particular switch or switches 130 activated. The encoder cards 110 use a buffer to store encoded video and audio data which is written to the storage device 104. Preferably the video data is written to the storage device 104 in temporal segments by the storage control module 111, as described above in connection with FIG. 1.

The control module 103 also signals the digital switch card 302 to activate an output device 140 through the digital switch card 302. In the illustrated embodiment, the output device 140 is a plurality of display monitors 305. The DVR 200 can be configured such that the particular display monitor(s) 305 activated depends on the particular switch or switches 130 activated.

Optionally, the output device can include a device 304 for signaling the status of the activity of the system 100 (FIG. 1). For example, in the illustrated embodiment, the device 304 could be configured to show whether a particular switch is activated or deactivated so that users of the system 100 are readily aware of the status of the system's activity. In the illustrated embodiment, the device 304 is a light indicating that a particular switch or switches 130 have been activated.

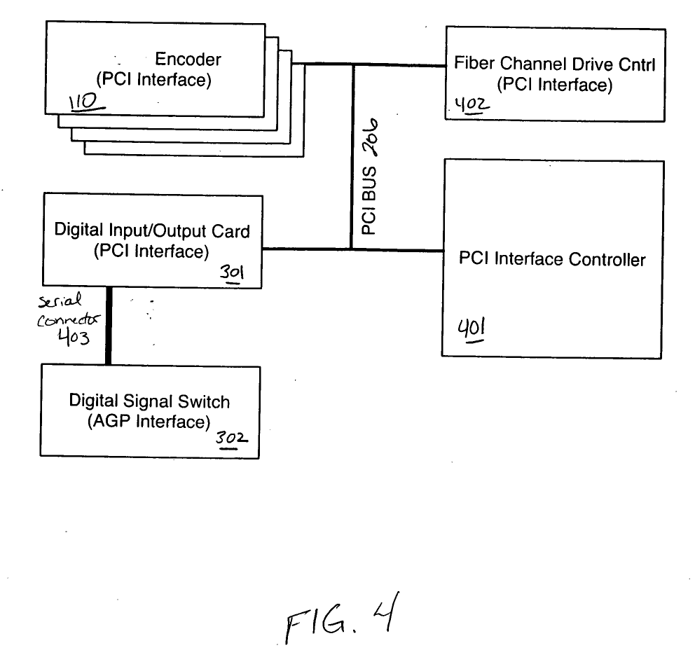

FIG. 4 is a block diagram depicting the interface connections of the DVR 200 of FIG. 2. The DVR 200 includes a number of encoder cards 110 and a digital input/output card 301, which are PCI interface cards. The DVR also includes fiber channel drive control circuitry 402 for controlling the interface with the storage device 104 and PCI Interface control circuitry 401 for controlling the PCI interfaces. These components 110, 402, 401, 301 use the PCI bus 206 to communicate with each other. The DVR 200 further includes a Digital Input/Output (I/O) Card 302 that operates on the accelerated graphics port (AGP) interface on the server 101 (FIG. 1). The digital I/O card 301 and the Digital Switch card use a serial connector to communicate, which is an RS488 serial connector in the illustrated embodiment, but can be any other serial connector.

It should be understood that FIGS. 2-4 illustrate exemplary configurations only and that structural, electrical and other changes, substitutions and supplements can be made.

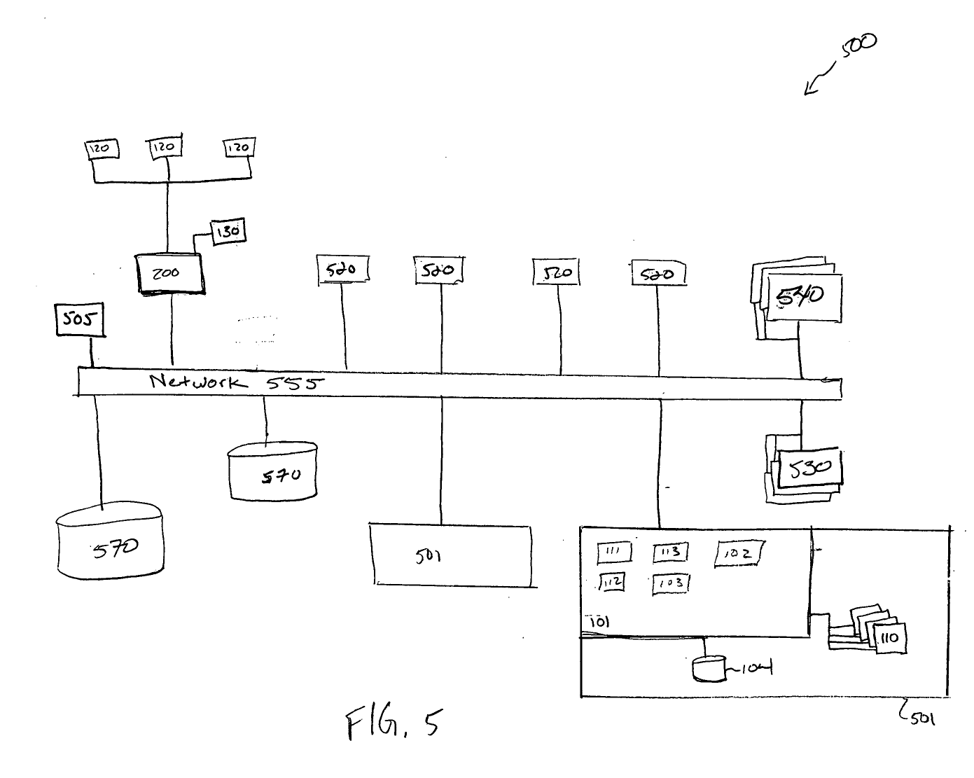

FIG. 5 illustrates a network video recorder (NVR) system 500 according to an exemplary embodiment of the invention. The system 500 includes a NVR 501 according to an exemplary embodiment of the invention. Preferably, the NVR 501 is capable of supporting harsh environments and uses solid state electronics so that it can withstand extreme vibration while recording. The NVR 501 is in communication with a computer network 555.

The NVR 501 is similar to the DVR 200 (FIGS. 1-4). The NVR 501 includes a server 101, such as a standard Intel-based server. An operating system 102, such as Windows 2000 or 2003 operating system and a control module 103 configured to control processes of the NVR 501 are also included. The server 101 also includes a storage control module 111, an activation control module 112, and, optionally, at least one other feature module 113. Each of the modules 103, 111, 112, 113 can be computer program applications running on the server 101 and function as described above in connection with FIG. 1. The NVR 501 also includes and video/audio encoder cards 110, for example Mpeg4 cards; and may include a storage device 140.

As shown in FIG. 5, additional devices can be part of the system 500 and in communication with the computer network 555. In the illustrated embodiment, the system 500 further includes video/audio input devices 520, a second NVR 501, a DVR 200 (which can be in further communication with devices 120, 130), one or more output devices 540, one or more activation devices 530 and one or more network storage devices 570.

The activation device(s) 530 is configured to signal the NVR 501 to begin recording video and audio data from the input devices 520. The activation device can be any device capable of communicating with the NVR 501 over the network 555 and providing an activation signal. Examples of possible activation devices include a switch, a client computer, a voice input device, a motion detector, a timer, an alarm device, among others. The input devices 520 are, for example, video cameras having audio recording devices. Additionally, since the NVR is in communication with the computer network 555, the NVR 501 can capture digital video and audio from any network-based source.

Since the NVR 501 is in communication with the network 555, the NVR can communicate with network storage devices 570. Accordingly, the storage control module 111 can write data to the network storage device(s) 570. Similar to the DVR 200, the NVR 501 storage module 111 can write user defined video segments to the storage device(s) 570 and can support a redundancy function.

The output device(s) 540 can be any device capable of communicating with the network 555 and outputting the video or audio data recorded by the NVR 501. Like the DVR 200, the NVR 501 can support multiple outputs from the input. In one embodiment, the NVR 501 can output four different streams (both audio and video) from a single input.

The system 500 also includes at least one user interface 505. In the illustrated example the user interface 505 is provided through a client computer in communication with the network 555.

Additionally, the NVR 501 is designed to consume considerably less power and less space than the DVR. The solid state design of the cards 110 in the unit consume very little power compared to a standard computer server, which can be used in the DVR 200. It particular, the DVR 200 can have Pentium 4 processors, which consume a large amount of power. The NVR 501 can include very low power microcontrollers, including Transmeta, AMD, National Semiconductor and Texas Instruments microcontrollers. Each encoder card 110 contains the circuitry to capture, encode and transmit the recoded video to a network storage array. The cards 110 operate individually without a central processor. Storage of the data is accomplished through the network 555. Therefore, internal storage on the NVR 500 can be eliminated. With fewer components than the DVR 200, the NVR 500 can also be configured to consume less space. For example, the DVR 200 can be about 4U (about 7 inches high) whereas the NVR 500 can be about 1U (about 1.75 inches high), where the other dimensions of the DVR 200 and NVR 500 are similar.

The DVR 200 and NVR 501 are self aware, meaning that they recognize their existence in the network 555 architecture and automatically configure themselves to broadcast their capabilities to the software hosted by, for example, the user interface 505. System administrators (not shown) then use this information to coordinate video captures through the network 555. Therefore, the network 555 can be readily scaled to include additional DVR 200 and/or NVR 501 devices to support thousands of simultaneous captures from both remote and local locations, as long as the network architecture supports the bandwidth and the connectivity.

The processes and devices described above illustrate preferred methods and typical devices of many that could be used and produced. The above description and drawings illustrate exemplary embodiments, which achieve the objects, features, and advantages of the present invention. It is not intended, however, that the present invention be strictly limited to the above-described and illustrated embodiments. Any modifications of the present invention that come within the spirit and scope of the following claims should be considered part of the present invention.

What is claimed as new and desired to be protected by Letters Patent of the United States is:

1. A digital video recording system comprising:
a video input device;
a storage device;
a video recording device configured to receive video input from the video input device, the video recording device comprising:
a server,
a plurality of video encoder cards, each card configured to convert analog video data to digital Mpeg4 video at a sustained rate of at least FD1, and
a storage control module configured to write user defined temporal video segments to the storage device;
an activation device configured to provide an activation signal to the video recording device; and
an output device capable of displaying video data recorded by the video recording device.

2. The system of claim 1, wherein at least two encoder cards convert analog video data from a same source simultaneously.

3. The system of claim 1, wherein the activation signal is generated by the activation device in response to one or more of the items in the group consisting of an event, motion, an alarm, a user determined schedule, and manual user input.

4. The system of claim 1, wherein the activation signal is generated by the activation device in response to voice input by a user.

5. The system of claim 1, wherein the activation signal is generated by the activation device under control of a computer program application in communication with the activation device.

6. The system of claim 1, wherein at least one encoder card is configured to convert analog audio data to digital audio data.

7. The system of claim 6, wherein the video recording device further comprises a module configured to translate languages.

8. The system of claim 6, wherein the video recording device further comprises a module configured to transcribe spoken words from recorded audio data.

9. The system of claim 6, wherein the video recording device further comprises a module configured to provide layered voice analysis and analyze audio data for deceptive or false statements.

10. The system of claim 1, wherein the video recording device further comprises a module configured for streaming of video content to the output device.

11. The system of claim 1, wherein the video recording device further comprises a module configured to process video images recorded by the video recording device to improve the quality of the images.

12. The system of claim 1, wherein the video recording device further comprises a module configured to enable user defined metadata capture in connection with video image recording.

13. The system of claim 1 further comprising a computer network, wherein the video recording device is in communication with the computer network.

14. A digital video recording device comprising:
a storage device;
a server;
a plurality of video encoder cards, each card configured to convert analog video data to digital Mpeg4 video at a sustained rate of at least FD1; and
a storage control module configured to write user defined temporal video segments to the storage device.

15. The device of claim 14, further comprising an activation module configured to receive an activation signal and to initiate video recording.

16. The device of claim 15, wherein the activation signal is one or more of the items in the group consisting of an event, motion, an alarm, a user determined schedule, and manual user input.

17. The device of claim 15, wherein the activation signal is generated is voice input by a user.

18. The device of claim 15, wherein the activation signal is a signal from a computer program application in communication with the activation module.

19. The device of claim 1, wherein at least two encoder cards convert analog video data from a same source simultaneously.

20. The device of claim 1, wherein at least one encoder card is configured to convert analog audio data to digital audio data.

21. The device of claim 20, further comprising a module configured to translate languages.

22. The device of claim 20, further comprising a module configured to transcribe spoken words from recorded audio data.

23. The device of claim 20, further comprising a module configured to provide layered voice analysis and analyze audio data for deceptive or false statements.

24. The device of claim 14, further comprising a module configured for streaming of video content to the output device.

25. The device of claim 14, further comprising a module configured to process video images recorded by the video recording device to improve the quality of the images.

26. The device of claim 14, further comprising a module configured to enable user defined metadata capture in connection with video image recording.

27. A method of recording video images, the method comprising the steps of:
receiving an activation signal;
receiving at least one stream of analog video signal from at least one source;
in response to the activation signal, simultaneously converting the at least one stream of analog video signal to Mpeg4 video data at a sustained rate of at least FD1;
at predetermined intervals during said act of converting, storing video data acquired during an immediately preceding interval to a storage device.

28. The method of claim 27, further comprising the acts of receiving at least one audio signal from at least one source and storing the signal as digital audio data on the storage device.

29. The method of claim 27, wherein the act of receiving an activation signal comprises receiving voice input by a user.

30. The method of claim 27, wherein the act of receiving an activation signal comprises receiving a signal from a computer program application in communication with the activation module.

31. The method of claim 27, wherein the at least one stream comprises two streams received from a same source at a same time.

32. The method of claim 31, further comprising the act of automatically translating a language from the audio data.

33. The method of claim 31, further comprising the act of automatically transcribing words from the audio data.

34. The method of claim 31, further comprising the act of automatically analyzing the audio data for deceptive or false statements.

35. The method of claim 27, further comprising the act of streaming video data to the output device.

36. The method of claim 27, further comprising the act of automatically processing the video data to improve a quality of images.

37. The method of claim 27, further comprising the act of storing metadata in connection with video data on the storage device.
